(19) United States
(12) Patent Application Publication
(10) Pub. No.: US 2003/0117498 A1
(43) Pub. Date: Jun. 26, 2003

(54) Description generation

(75) Inventors: Richard S. Cole, Redhill (GB); Richard M. Miller-Smith, Lingfield (GB)

Correspondence Address: PHILIPS ELECTRONICS NORTH AMERICAN CORP, 580 WHITE PLAINS RD, TARRYTOWN, NY, 10591, US

(73) Assignee: KONINKLIJKE PHILIPS ELECTRONICS N.V.

(21) Appl. No.: 10/323,392

(22) Filed: Dec. 19, 2002

(30) Foreign Application Priority Data
Dec. 22, 2001 (GB) 0130802.2

(51) Int. Cl. H04N 5/225

(52) U.S. Cl. 348/207.99

(57) ABSTRACT

Apparatus for generating, from an environment, a description in the form of metadata such as an instruction set of a markup language comprises first sensor means for sensing a first aspect of the environment and converting means for converting the aspect into the metadata.

This invention relates to apparatus for and a method of generating, from an environment, a description in the form of metadata, particularly an instruction set of a markup language.

In order to record aspects of an environment, use of a camera to record images is well known. Simple augmentation of the recorded images is also known.

U.S. Pat. No. 6,128,037 discloses a method and system for automatically adding sound to images in a digital camera. The method and system include the ability to post-annotate a previously captured image. This is accomplished by placing the digital camera in review mode, selecting the image cell in a view finder corresponding to the previously captured image, recording a sound clip; and then attaching the sound clip to the previously captured image.

EP-A2-0920179 relates to a photographic system involving data collection from a communicating scene, e.g. a visitor attraction site, that is capable of interactive communication with a user. The attraction site stores content data related to the site, and the user communicates with the attraction site through a camera capable of communication with the site. Besides capturing an image associated with the site, the camera stores predetermined personality data that relates an interest of the user to at least a portion of the content data and includes means for transferring the personality data to the attraction site. The camera further includes means for receiving and displaying the portion of the content data from the attraction site, and a user interface for selecting from the displayed content data that part which the user wants to keep. In this manner, information relevant to a user's interests about a photographed item can be easily requested, accessed and stored with the specific pictures that the user has captured.

US-B1-6223190 discloses a method and system for generating an HTML (hypertext markup language) file including images captured by a digital imaging device, the digital imaging device having a display. A script and its predefined model are provided to the digital camera. The script is comprised of a set of software program instructions. The digital camera executes the script to display interactive instructions on the display that prompt a user to perform specific operations. In response to the user performing the specific operations, the digital camera automatically updates the interactive instructions, such that the user is guided through a series of related image captures to obtain a series of resulting images. The digital camera then generates an HTML file including the resulting images, wherein the HTML file is formatted in accordance with the predefined model.

None of these known devices however record the aspects of the environment in anything other than the form of the original raw data.

It is therefore an object of the invention to improve upon the known devices.

According to a first aspect of the present invention, there is provided apparatus for generating, from an environment, a description in the form of metadata, comprising first sensor means for sensing a first aspect of said environment and converting means for converting said aspect into said metadata.

According to a second aspect of the present invention, there is provided a method of generating, from an environment, a description in the form of metadata, comprising sensing a first aspect of said environment and converting said aspect into said metadata.

Owing to the invention, it is possible to generate metadata relating to aspects of the environment.

Advantageously, the first sensor means is an image sensor. Preferably, further sensing means for sensing further aspects of the environment are provided. Recording means for recording said metadata or transmitting means for transmitting said metadata can be included. Ideally, the metadata is an instruction set of a markup language.

Embodiments of the invention will now be described, by way of example only, with reference to the accompanying drawings, in which:—

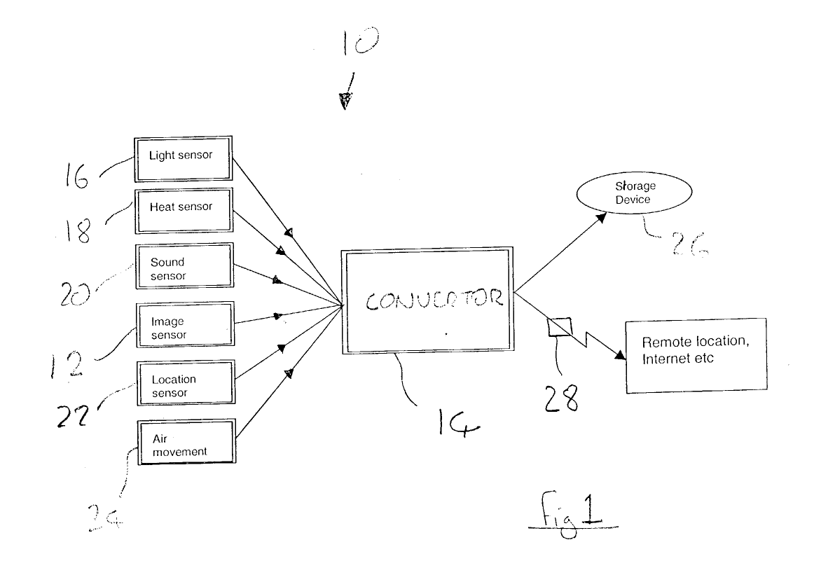

FIG. 1 is a schematic representation of apparatus for generating, from an environment, a description in the form of metadata.

In the FIGURE, the apparatus 10 comprises first sensor means 12 for sensing a first aspect of the environment. The sensor means is an image sensor 12 that operates in the same manner as a digital camera and senses a first aspect of the environment, which is the image of the environment. The image sensor 12 has the facility to sense still or moving images.

The apparatus 10 also comprises converting means 14 for converting the aspect (the image of the environment) into metadata. The converting means 14 is a processor with suitable memory capacity. The converting means 14 receives the raw data from the image sensor 12 and processes this information to produce metadata. This is to be distinguished from the normal process in a digital camera, whereby the image received by the camera is converted into a binary data stream according to a predetermined protocol, for conversion later, back to the original image. For example, the environment that the apparatus 10 is experiencing may be a park. In this case the image sensor 12 senses the image of the park and passes this to the converting means 14, which produces metadata. This metadata is of the form of an instruction set of a markup language and therefore in this example may comprise <TREES>, <GRASS>, and <BLUE SKY>.

In addition to the image sensor 12, the apparatus 10 is provided with further sensing means for sensing further aspects of the environment. These are shown as light sensor 16, heat sensor 18, sound sensor 20, location sensor 22 and air movement sensor 24. It will be appreciated that any aspect of the environment can be sensed, as long as the suitable sensor can be provided. For example, smells could be sensed.

Each sensor senses an aspect of the environment and passes information relating to that aspect to the converting means 14. The light sensor 16 will measure the luminance levels and colour grades that are present in the environment and pass the raw data to the converting means 14. In the example above, where the environment is a park, the converting means 14 produces metadata in the form of an instruction set of a markup language, which may comprise <BRIGHT> and <GREEN>.

Likewise, the heat sensor 18 will sense the temperature of the environment, typically as degrees centigrade and pass this raw data to the converting means 14 that will convert this information into metadata. For example, 24° C. will be converted into <WARM> by the converting means 14.

The sound sensor 20 senses the audio aspect of the environment, and again the converting means 14 receives the raw data from the sensor 20 and converts this into metadata. In the example of the park, this metadata may be <RUSTLING LEAVES> and <SONGBIRDS>.

The location sensor 22 uses GPS (Global Positioning System) to determine the position of the apparatus 10. The location sensor 22 also has the functionality to determine the direction in which the image sensor 12 is pointing when it is acquiring data and to detect the direction that sounds are coming from. For example, if the apparatus 10 is near the coast, the location sensor will pass this data to the converting means 14 which will produce the metadata <SEASIDE>.

Air movement is sensed by the sensor 24, which senses air speed, direction and type of movement. Again this raw data is passed to the converting means 14 that converts this data into metadata, which may be, for example <LIGHT BREEZE>.

Included in the apparatus 10, but not shown, is a time device. This time device is read by the converting means 14 and is used to produce such metadata as <NIGHT> or <DAWN> etc. as appropriate. In combination with information from the location sensor 22, information such as the position of the sun in the sky can be determined, and the converting means 14 may produce metadata such as <NOONDAY SUN>.

Therefore it can be seen that the different aspects of the environment are sensed by the different sensor means of the apparatus 10, and converted into high level descriptions of that environment by the converting means 14. The converting means generates an instruction set of a markup language that describes the different aspects of the environment in general terms only. It is not possible to generate, in reverse, the raw data from the high level descriptions.

The apparatus 10 is also provided with recording means 26 for recording the metadata produced by the converting means 14. This recording means 26 can be any suitable storage device, such as a hard disc or flash memory. The recording means 26 is connected to the converting means 14 and receives from the converting means 14 the generated metadata that describes the local environment. This allows the description to be stored locally on the apparatus for later transfer, viewing or distribution.

The apparatus 10 further comprises transmitting means 28 for transmitting the metadata. The transmitting means 28 could be a microwave or short range RF transmitter, for example of the Bluetooth standard or could be a long distance radio broadcast. This allows the metadata to be transmitted in real time (or in batches) to locations remote from the environment that is being sensed and converted into metadata by the apparatus 10. In a similar fashion to a web-cam, the apparatus 10 can be connected directly to an external network, for example, the Internet.

The apparatus 10 may also be connected, wired or wirelessly, to a device or set of devices that can render the metadata. This device or set of devices receive the metadata and according to their functionality produce effects corresponding to the description in the metadata. Typically the devices would include display, lighting and audio devices.

The converting means 14 also has the functionality to convert two or more of the aspects of the environment into the metadata. For example if the heat sensor 18 is sensing a low temperature, and the light sensor 16 is sensing a low level of light, then the converting means could produce, for example, the description <WINTER>.

An advantage of the present embodiment is that, since the metadata is editable, the experience can be edited and/or augmented or used as the basis for other experiences, combined with other descriptions (authored or captured). At a higher level of complexity, the sensing means 12 can, through image analysis, identify objects and their spatial relationships, which can then be converted by the converting means to appropriate metadata. The form that the metadata takes can be any suitable high level description, such as MPEG-7 metadata.

1. Apparatus for generating, from an environment, a description in the form of metadata, comprising first sensor means for sensing a first aspect of said environment and converting means for converting said aspect into said metadata.

2. Apparatus according to claim 1, wherein said first sensor means is an image sensor.

3. Apparatus according to claim 1, and further comprising further sensing means for sensing further aspects of the environment.

4. Apparatus according to claim 1, and further comprising recording means for recording said metadata.

5. Apparatus according to claim 1, and further comprising transmitting means for transmitting said metadata.

6. A method of generating, from an environment, a description in the form of metadata, comprising sensing a first aspect of said environment and converting said aspect into said metadata.

7. A method according to claim 6, wherein said first aspect is the image of the environment.

8. A method according to claim 6, and further comprising sensing further aspects of the environment.

9. A method according to claim 6, and further comprising recording said metadata.

10. A method according to claim 6, and further comprising transmitting said metadata.

11. A method according to claim 6, wherein said converting further comprises converting two or more aspects of the environment into said metadata.

12. A method according to of claim 6, wherein said metadata is an instruction set of a markup language.
